(19) United States
(12) Patent Application Publication
(10) Pub. No.: US 2011/0192829 A1
(43) Pub. Date: Aug. 11, 2011

(54) WELDING GUN

(75) Inventors: Koichi Matsumoto, Hagagun (JP); Hiroshi Miwa, Hagagun (JP)

(73) Assignee: HONDA MOTOR CO., LTD., Tokyo (JP)

(21) Appl. No.: 13/012,178

(22) Filed: Jan. 24, 2011

(30) Foreign Application Priority Data
Feb. 5, 2010 (JP) 2010-023963

(51) Int. Cl. B23K 9/00

(52) U.S. Cl. 219/136; 219/137.31

(57) ABSTRACT

A welding gun is provided that can endure high loads due to increasing the lead of the ball screw, while also being able to achieve a reduction in the size of a motor driving the ball screw. A welding gun equipped with a servo motor (10) as a drive source, includes: a hollow rod (43) that causes a moveable electrode tip (62) to advance and retract, a ball nut (42) that is coupled to the hollow rod (43), and a ball screw (41) that threadedly engages with the ball nut (42), in which a planetary gear reduction mechanism (70) is attached to the output shaft of the servo motor (10), and the ball screw (41) is attached to the output shaft of the reduction mechanism.

This application is based on and claims the benefit of priority from Japanese Patent Application No. 2010-023963, filed on 5 Feb. 2010, the content of which is incorporated herein by reference.

### BACKGROUND OF THE INVENTION

1. Field of the Invention

The present invention relates to a welding gun. More specifically, the present invention relates to a welding gun provided with a reduction mechanism between an output shaft of a hollow motor, which is a drive source, and a ball screw.

2. Related Art

Conventionally, among welding guns equipped with a rod that is driven by a motor and has a region that is drawn into the motor, a welding gun has been known in which a rotational shaft of the motor is formed as a hollow shaft, a ball screw shaft end is fixed to this rotational shaft, a ball nut threadedly engaging with this ball screw shaft is fixed at an end portion of the rod, and the rod and ball nut can move in an inner circumference part of the rotational shaft of the motor. As a technique to reduce the size and weight of such a welding gun using a hollow motor, the size of the ball screw has been reduced by reducing the lead of the ball screw, and high thrust has been obtained from a smaller motor by raising the reduction ratio. The welding gun described in Japanese Unexamined Patent Application Publication No. 2001-293577 has been known as such a welding gun.

### SUMMARY OF THE INVENTION

However, there has been a problem in that, if the lead of the ball screw is decreased in order to raise the reduction ratio, the hard sphere diameter built into the ball screw becomes smaller, and thus high thrust cannot be accepted. In this circumstance, if the lead of the ball screw is increased, since the hard sphere diameter built into the ball screw can be increased, and further, a technique of increasing the number of grooves in the ball screw can be adopted, it becomes possible to manufacture a ball screw that achieves both high load capability and a reduction in size.

However, if the lead of the ball screw is increased, there is no other choice but to increase the size of the motor to make the high torque required for the motor driving the ball screw, and thus it has not been possible to have both high load (high pressure) capacity of the ball screw and a reduction in the size of the motor.

The present invention was made taking the aforementioned problems into account, and has an object of providing a welding gun in which a reduction mechanism is attached to an output shaft of a hollow motor and a ball screw in which the lead is increased is attached to the output shaft of this reduction mechanism, whereby it is possible to use a ball screw that can endure high loads (high pressure) by increasing the thread number of the ball screw, while also being able to achieve a reduction in the size of the motor driving the ball screw due to having this reduction mechanism, a result of which both high thrust and a size reduction are attained.

Furthermore, the present invention has an object of providing a welding gun in which the drive unit is slimmed by coaxially laying out the hollow motor, reduction mechanism and hollow rod, thereby making weight savings and size reduction possible.

According to a first aspect of the invention, a welding gun (e.g., the electric spot welding gun 1 described later) equipped with a hollow motor (e.g., the servo motor 10 described later) as a drive source, includes: a pressure shaft (e.g., the hollow rod 43 described later) that causes an electrode tip (e.g., the moveable electrode tip 62 described later) to advance and retract; a ball nut (e.g., the ball nut 42 described later) that is coupled to the pressure shaft; and a ball screw (e.g., the ball screw 41 described later) that threadedly engages with the ball nut, in which a reduction mechanism (e.g., the planetary gear reduction mechanism 70 or planetary gear reduction mechanism 80) is attached to an output shaft of the hollow motor, and the ball screw is attached to an output shaft of the reduction mechanism.

According to the first aspect of the invention, the reduction mechanism is mounted between the output shaft of the hollow motor and the ball screw.

With this configuration, high loads can be endured since it is no longer necessary to have a function of a reduction mechanism in the ball screw and the lead of the ball screw can be lengthened, by increasing the motor torque at the portion of the reduction mechanism.

In addition, since the reduction ratio can be maintained by mounting the reduction mechanism, it is possible to achieve high output (high pressure) even if the hollow motor is reduced in size; therefore, a reduction in the size of the welding gun can be achieved.

According to a second aspect of the invention, in the welding gun as described in the first aspect, the reduction mechanism and the ball screw are disposed coaxially.

According to the second aspect, in addition to the effects of the first aspect, it is possible to achieve a more compact welding gun in the width or height direction.

According to the present invention, it is possible to provide a welding gun that can endure high loads due to increasing the lead of the ball screw, while also being able to achieve a reduction in the size of the motor driving the ball screw.

### BRIEF DESCRIPTION OF THE DRAWINGS

FIG. 1 is a partial simplified side view showing an electric spot welding gun according to an embodiment of the present invention in a state attached to a leading end of a robot arm;

FIG. 2 is a longitudinal sectional view of an electric spot welding gun according to a first embodiment of the present invention;

FIG. 3 is a cross-sectional view along the line A-A in FIG. 2;

FIG. 4 is a cross-sectional view along the line B-B in FIG. 2;

FIG. 5 is a longitudinal sectional view of an electric spot welding gun according to a second embodiment of the present invention;

FIG. 6 is a cross-sectional view along the line C-C in FIG. 5;

FIG. 7 is a cross-sectional view along the line D-D in FIG. 5; and

FIG. 8 is a cross-sectional view along the line E-E in FIG. 5.

### DETAILED DESCRIPTION OF THE INVENTION

Hereinafter, embodiments of the present invention will be explained based on the drawings.

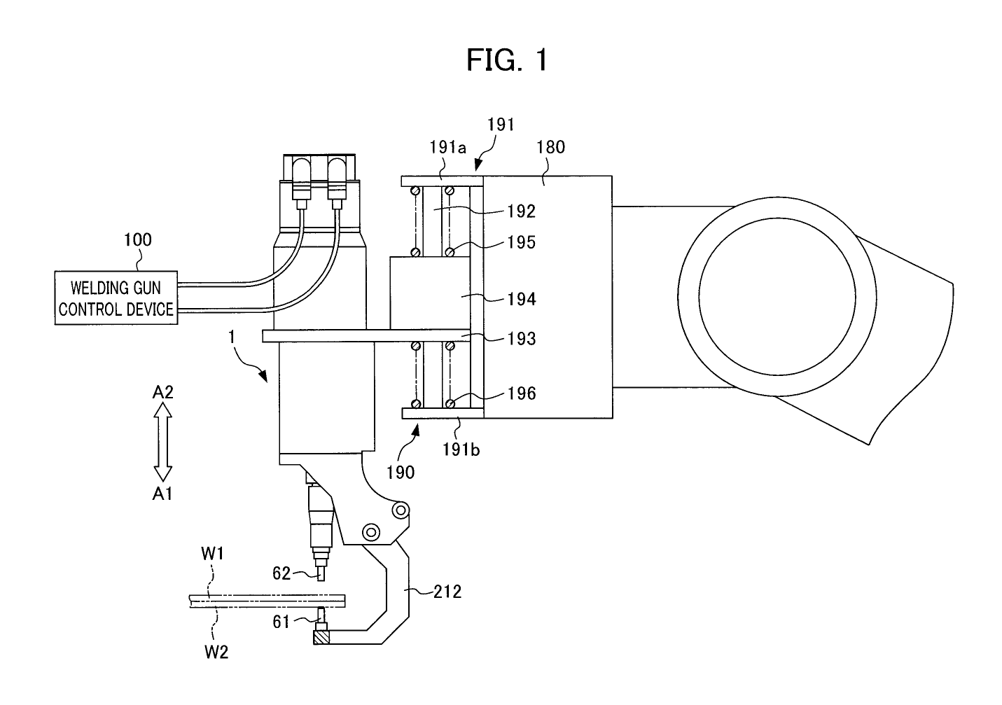

FIG. 1 is a partial simplified side view showing an electric spot welding gun 1 according to an embodiment of the present invention in a state attached to a leading end of a robot arm 180.

The electric spot welding gun 1 is attached to a gun support portion 190 provided to the leading end of the robot arm 180. In addition, a welding gun control device 100 is electrically connected to the electric spot welding gun 1. Moreover, as described later, the electric spot welding gun 1 is configured as a C-type welding gun that reciprocally moves a moveable electrode tip 62 in an arrow A1 direction or an arrow A2 direction relative to a fixed electrode tip 61, which is fixed at a leading end side (arrow A1 side shown in FIG. 1) by a fixed electrode tip mounting portion 212, so as to open and close between the fixed electrode tip 61 and the moveable electrode tip 62.

The gun support portion 190 includes a gun support bracket 191, and this gun support bracket 191 includes a top plate 191a and a bottom plate 191b that extends in parallel with this top plate 191a. A guide bar 192 is bridged between the top plate 191a and the bottom plate 191b.

A plate 193, which is slidable in the axial direction of the guide bar 192 and is parallel to the top plate 191a and the bottom plate 191b, fits to the guide bar 192. A support 194 of a cabinet shape is arranged on top of the plate 193 on a side near the robot arm 180, and a first coil spring 195 wound around the guide bar 192 is interposed between the top plate 191a and the support 194. Similarly, a second coil spring 196 wound around the guide bar 192 is interposed between the bottom plate 191b and the plate 193.

In addition, the plate 193 fastens and retains the electric spot welding gun 1 on a side separated from the robot arm 180.

The electric spot welding gun 1 is disposed so as to position works W1 and W2, which are welding target members, between the fixed electrode tip 61 and the moveable electrode tip 62 by the movement of the robot arm 180 and the gun support portion 190. Then, according to the control of the welding gun control device 100, the electric spot welding gun 1 causes the moveable electrode tip 62 to move relative to the fixed electrode tip 61 to the arrow A1 side, and then welds the works N1 and W2 together.

Next, the configuration of the electric spot welding gun 1 will be explained.

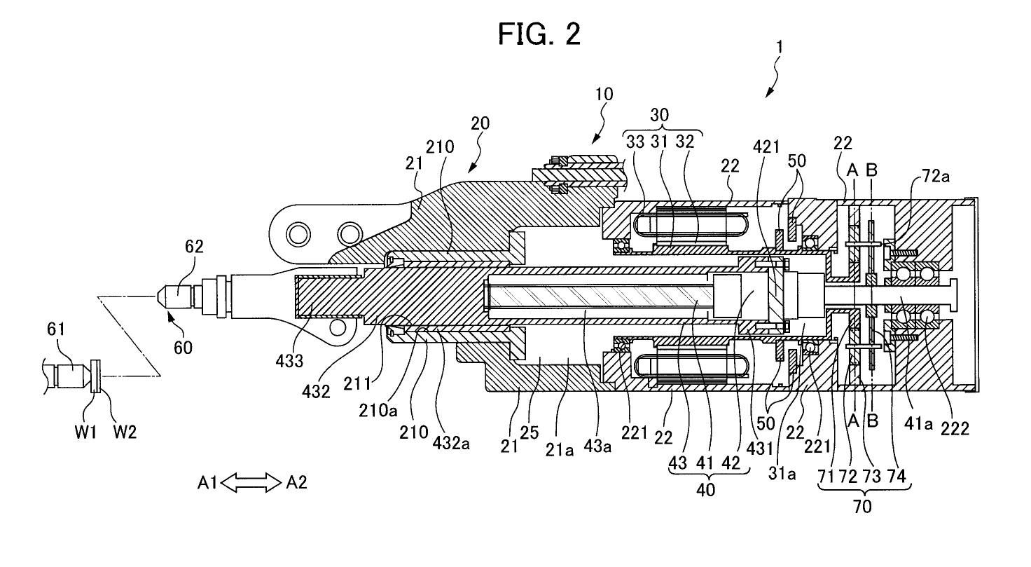

FIG. 2 is a longitudinal sectional view of the electric spot welding gun 1 according to a first embodiment of the present invention.

Hereinafter, each configuration of the electric spot welding gun 1 will be explained.

The electric spot welding gun 1 includes a servo motor 10 having a motor housing 20, motor 30 and a hollow encoder 50, a feed screw mechanism 40, electrode tips 60, and a planetary gear reduction mechanism 70.

The planetary gear reduction mechanism 70 is coupled to the servo motor 10 at a base end side of the servo motor 10 (arrow A2 side shown in FIG. 2).

The feed screw mechanism 40 is coupled to the planetary gear reduction mechanism 70 at a base end side of the feed screw mechanism 40 (arrow A2 side shown in FIG. 2).

One of the electrode tips 60 is provided to a leading end side of the feed screw mechanism (arrow A1 side shown in FIG. 2).

The servo motor 10 includes a motor housing 20 that forms a main body of the electric spot welding gun 1 and accommodates a portion of the feed screw mechanism 40, and a motor 30 that is accommodated in the motor housing 20 and rotationally drives the hollow rotor 31 by way of electric power supplied from the welding gun control device 100 (refer to FIG. 1).

The motor housing 20 includes a casing 21 that supports the leading end side (arrow A1 side shown in FIG. 2) of the feed screw mechanism 40, and a motor cover 22 that is coupled to a base end side (arrow A2 side shown in FIG. 2) of the casing 21 and accommodates the motor 30.

The casing 21 is fastened and retained to the plate 193 of the gun support portion 190 (refer to FIG. 1) that is provided to the leading end of the robot arm 180 (refer to FIG. 1).

In addition, the casing 21 has a rod support portion 210 that supports a leading end side (arrow A1 side shown in FIG. 2) of the hollow rod 43 of the feed screw mechanism 40 to be reciprocally moveable. A portion of the hollow rod 43 travels in and out of the motor housing 20 by sliding and passing through this rod support portion 210.

A rod-support portion hollow part 211 through which the hollow rod 43 passes is formed in the rod support portion 210. A plurality of spline grooves 210a extending in the direction in which the hollow rod 43 reciprocally moves is formed in the rod support portion 210 in an inside wall forming the rod-support portion hollow part 211. These spline grooves 210a engage to be reciprocally moveable with splines 432a described later, which are formed in the hollow rod 43. As a result, the hollow rod 43 reciprocally moves without being allowed to rotate relative to the servo motor 10.

In addition, a casing hollow part 21a that accommodates a portion of the hollow rod 43 to be reciprocally movable is formed in the casing 21.

The motor cover 22 is connected to a base end portion (arrow A2 direction shown in FIG. 2) of the casing 21, and rotatably retains the hollow rotor 31 of the motor 30 via a bearing 221.

In addition, the motor cover 22 rotatably retains a threaded shaft 41a, described later, of the ball screw 41 via an angular bearing 222.

The motor 30 includes the hollow rotor 31 formed in a tube shape, a magnet 32 of a ring-shape that is adhered to the outer circumference of the hollow rotor 31, and a coil 33 of a ring-shape disposed at a position facing this magnet 32. In other words, the motor 30 is accommodated in the motor cover 22, with the magnet 32 disposed on the outer circumference of the hollow rotor 31 centered around this hollow rotor 31, and the coil 33 disposed so as to face the outside circumference of this magnet 32.

The hollow rotor 31 is formed as a tube in which a leading end (arrow A1 side shown in FIG. 2) is opened and a base end (arrow A2 side shown in FIG. 2) is integrally formed with a sun gear 71, described later, of the planetary gear reduction mechanism 70. Furthermore, a rotor hollow part 31a formed in the hollow rotor 31. This rotor hollow part 31a accommodates a portion of the hollow rod 43 of the feed screw mechanism 40 to be reciprocally moveable. The rotor hollow part 31a is made to be a continuous space linked with the casing hollow part 21a of the casing 21, together forming a motor housing hollow part 25. In other words, a portion of the hollow rod 43 reciprocally moves in this motor housing hollow part 25.

The coil 33 generates a magnetic field from electric current supplied from the welding gun control device 100 (refer to FIG. 1) being passed therethrough. The hollow rotor 31 rotates in a direction corresponding to the polarity of the current and at a speed corresponding to the electric power supplied, by way of the interaction between the magnetic field generated by this coil 33 and the magnetic field of the magnet 32 adhered to the hollow rotor 31.

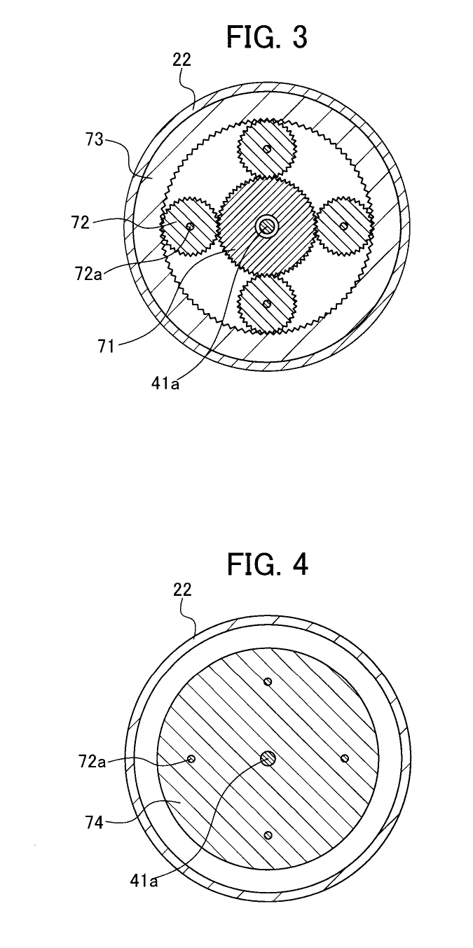

Herein, the configuration of the planetary gear reduction mechanism 70 will be explained while referring to FIGS. 3 and 4 along with FIG. 2.

FIG. 3 is a cross-sectional view along the line A-A in FIG. 2.

FIG. 4 is a cross-sectional view along the line B-B in FIG. 2.

The planetary gear reduction mechanism 70 includes a sun gear 71 that is formed to couple with the hollow rotor 31, planet gears 72, a ring gear 73, and a carrier 74. The sun gear 71 engages with the planet gears 72, and the planet gears 72 engage with the sun gear 71 and the ring gear 73.

An inner circumferential surface of the ring gear 73 engages with the planet gear 72. The outer circumferential surface thereof is fixed to the motor cover 22.

The planet gears 72 are coupled to the carrier 74 via shafts 72a. In addition, the carrier 74 is coupled at the central part thereof to the threaded shaft 41a, described later, of the ball screw 41.

When the hollow rotor 31 rotates, the sun gear 71 rotates in conjunction with the rotation of the hollow rotor 31. The planet gears 72 rotate (spin) about the shafts 72a in the opposite direction to the rotational direction of the sun gear 71, and rotate (revolve) around the circumference of the sun gear 71 in the same direction as the rotational direction of the sun gear 71, about the rotational axis of the sun gear 71.

Furthermore, the carrier 74 rotates in the same direction as the rotational direction of the sun gear 71 via the shafts 72a, in conjunction with the revolving of the planet gears 72.

As a result, the screw shaft 41a rotates and the ball screw 41 rotates in the same direction as the rotational direction of the sun gear 71.

By providing the planetary gear reduction mechanism 70 in this way, the rotational speed of the sun gear 71 is reduced according to the predetermined reduction ratio of the planetary gear reduction mechanism 70, and the carrier 74 rotates at this reduced rotational speed. Therefore, the rotational force (torque) of the hollow rotor 31 is increased according to the predetermined reduction ratio of the planetary gear reduction mechanism 70. The ball screw 41 then rotates with this increased rotational force.

Referring back to FIG. 2, the feed screw mechanism 40 includes the ball screw 41, the ball nut 42 that threadedly engages with this ball screw 41, and the hollow rod 43 that is fixed to this ball nut 42.

The ball screw 41 has the threaded shaft 41a at a base end thereof (arrow A2 side shown in FIG. 2). This threaded shaft 41a is coupled to the carrier 74 of the planetary gear reduction mechanism 70.

With this configuration, the ball screw 41 rotates via the planetary gear reduction mechanism 70 in conjunction with the rotation of the hollow rotor 31. At this time, the rotational force (torque) of the hollow rotor 31 is increased according to the predetermined reduction ratio of the planetary gear reduction mechanism 70. The ball screw 41 then rotates with this increased rotational force.

The ball nut 42 reciprocally moves in the axial direction of this ball screw 41 in conjunction with the rotation of the ball screw 41. The hollow rod 43 reciprocally moves in conjunction with the reciprocal movement of the ball nut 42.

It should be noted that the servo motor 10, the planetary gear reduction mechanism 70, and the ball screw 41 are disposed coaxially about the threaded shaft 41a.

It should also be noted that the ball screw 41 extends in substantially the center of the motor housing hollow part 25.

In addition, the ball nut 42 is formed with a slightly smaller diameter relative to the diameter of the rotor hollow part 31a, and has a hollow rod mounting portion 421 to which the hollow rod 43 is fixed.

The hollow rod 43 includes a hollow-rod base end portion 431 formed with substantially the same diameter as the hollow rod mounting portion 421 and coupled to this hollow rod mounting portion 421, a shaft 432 that extends from this hollow-rod base end portion 431, slides and passes through the rod support portion 210 of the casing 21, to project to outside, and a moveable electrode tip mounting portion 433 that is provided to a leading end (arrow A1 side end portion shown in FIG. 2) of this shaft 432 and to which the moveable electrode tip 62 among the electrode tips 60 is attached.

In this way, the hollow rod mounting part 421 and the hollow-rod base end portion 431 of the feed screw mechanism 40 are formed with slightly smaller diameters relative to the diameter of the rotor hollow part 31a.

A rod hollow part 43a in which the ball screw 41 extends is formed in the shaft 432. In addition, splines 432a, which engage with a plurality of spline grooves 210a formed in an inner wall forming the rod-support portion hollow part 211, are formed in the shaft 432 in a portion sliding against the rod support portion 210.

In this way, the splines 432a mutually engage with the spline grooves 210a. As a result, the hollow rod 43 reciprocally moves in the axial direction of the shaft 432 without being allowed to rotate in conjunction with the rotation of the ball screw 41.

The hollow encoder 50 is configured by a fixed portion and a rotating portion that oppose each other. The fixed portion is connected to the motor cover 22, and the rotating portion is connected to the hollow rotor 31. The hollow encoder 50 detects the rotational angle of the hollow rotor 31.

The electrode tips 60 are a pair of electrode tips that sandwich and weld works W1 and W2, and include a fixed electrode tip 61 and a moveable electrode tip 62.

The fixed electrode tip 61 is detachably mounted to a fixed electrode tip mounting portion 212 (refer to FIG. 1), which extends from the casing 21.

The moveable electrode tip 62 is detachably mounted to the moveable electrode tip mounting portion 433 of the hollow rod 43, and opens and closes relative to the fixed electrode tip 61 by way of the reciprocal movement of the hollow rod 43.

Herein, operation of the electric spot welding gun 1 will be explained.

With the electric spot welding gun 1, when current is supplied to the coil 33 of the motor 30 from the welding gun control device 100 (refer to FIG. 1), the hollow rotor 31 rotates in a predetermined direction. The ball screw 41 of the feed screw mechanism 40 also rotates via the planetary gear reduction mechanism 70 in conjunction with the rotation of this hollow rotor 31. At this time, the rotational force (torque) of the hollow rotor 31 is increased by the rotational speed of the hollow rotor 31 being reduced at the predetermined reduction ratio of the planetary gear reduction mechanism 70. The ball screw 41 then rotates with the increased rotational force. The ball nut 42 and the hollow rod 43 move to the leading end side of the ball screw 41 (arrow A1 side shown in FIG. 2) in conjunction with the rotation of the ball screw 41. As a result, the moveable electrode tip 62 attached to a leading end of the hollow rod 43 closes relative to the fixed electrode tip 61, thereby retaining the works W1 and W2 under pressure. In this state, high current is supplied between the fixed electrode tip 61 and the moveable electrode tip 62, whereby the works W1 and W2 are spot welded.

Next, an electric spot welding gun 1 according to a second embodiment of the present invention will be explained.

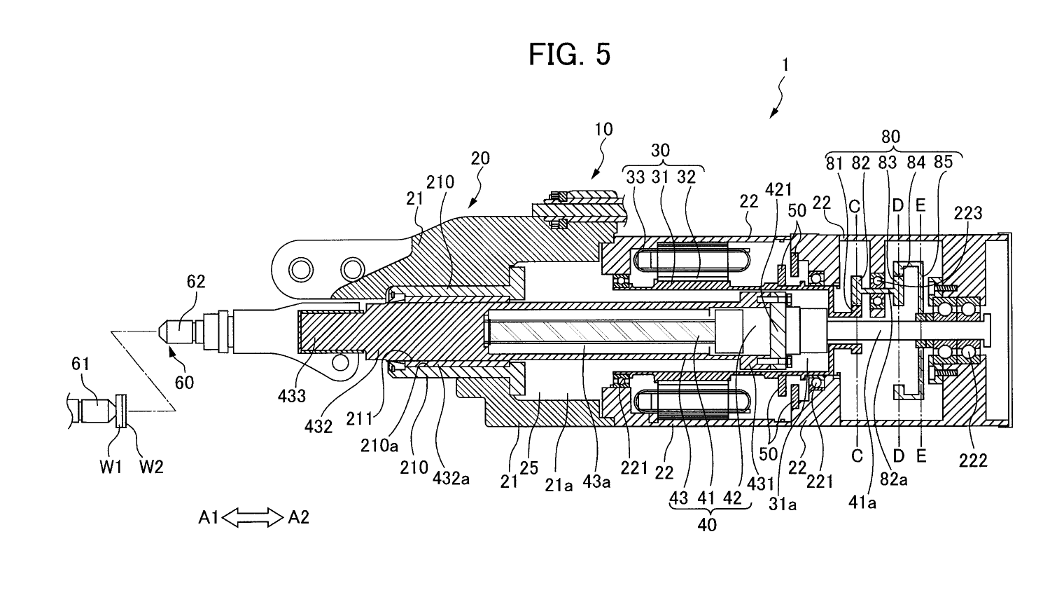

FIG. 5 is a longitudinal sectional view of the electric spot welding gun 1 according to the second embodiment of the present invention.

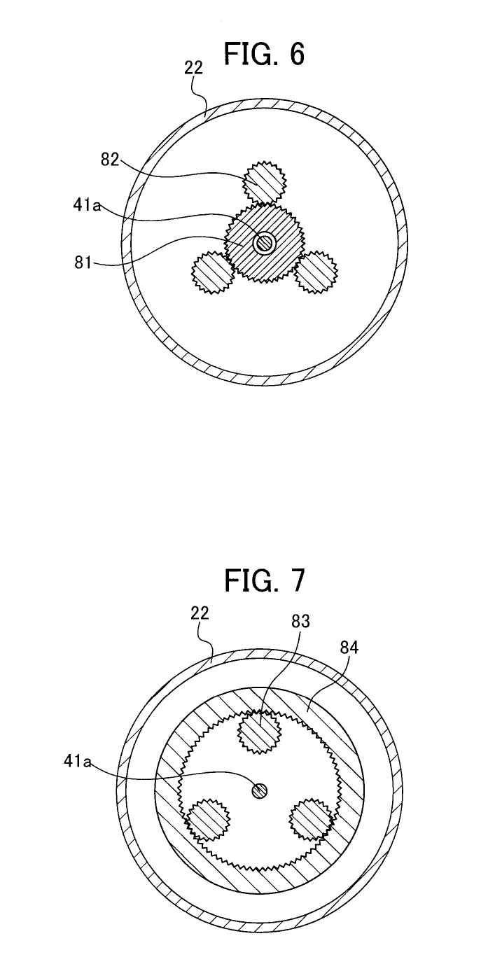

FIG. 6 is a cross-sectional view along the line C-C in FIG. 5.

FIG. 7 is a cross-sectional view along the line D-D in FIG. 5.

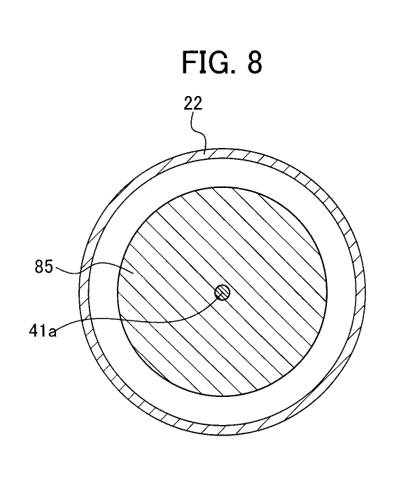

FIG. 8 is a cross-sectional view along the line E-E in FIG. 5.

As shown in FIG. 5, a planetary gear reduction mechanism 80 is used in the second embodiment in place of the planetary gear reduction mechanism 70 of the first embodiment. Therefore, except for the planetary gear reduction mechanism 80, configurations of the second embodiment are assigned the same reference symbols in the drawings due to being substantially the same as the first embodiment, and explanations thereof are omitted.

The planetary gear reduction mechanism 80 includes a sun gear 81 that is formed to couple with the hollow rotor 31, planet gears 82 and 83, a ring gear 84 and a carrier 85. The sun gear 81 engages with the planet gears 82, and the planet gears 83 engage with the ring gear 84.

The planet gears 82 and 83 are integrated by being coupled together to shafts 82a. Furthermore, the shafts 82a are rotatably retained via bearings 223 by the motor cover 22. The rotation of the planet gears 82 and 83 is spinning about the shafts 82a, and not revolving around the circumference of the sun gear 81. This makes the planet gears 82 and 83 have the same rotational direction and the same rotational speed.

The ring gear 84 engages with the planet gears 83 at an inner circumferential surface thereof, as described previously, and is formed to be integrally coupled with the carrier 85. In addition, the carrier 85 is coupled at the center thereof to the threaded shaft 41a of the ball screw 41

When the hollow rotor 31 rotates, the sun gear 81 rotates in conjunction with the rotation of the hollow rotor 31. The planet gears 82 and 83 rotate (spin) in the opposite direction to the rotational direction of the sun gear 81 about the shafts 82a, in conjunction with the rotation of the sun gear 81.

Furthermore, the carrier 85 rotates in the opposite direction to the rotational direction of the sun gear 81, in conjunction with the rotation of the planet gear 83.

With this, the screw shaft 41a and the ball screw 41 rotate in the opposite direction to the rotational direction of the sun gear 81.

It should be noted that the diameter of the ring gear 84 is larger than the diameter of the sun gear 81. In addition, the planet gears 82 and 83 are integrated via the shafts 82a and are the same diameter. Therefore, the rotational speed of the sun gear 81 is reduced according to the predetermined reduction ratio of the planetary gear reduction mechanism 80, and the carrier 85 rotates at this reduced rotational speed, a result of which the rotational force (torque) of the hollow rotor 31 becomes increased and transmitted to the ball screw 41.

The ball screw 41 has the threaded shaft 41a at a base end (arrow A2 side shown in FIG. 2). This threaded shaft 41a is coupled to the carrier 85 of the planetary gear reduction mechanism 80.

As a result, the ball screw 41 rotates via the planetary gear reduction mechanism 80 in conjunction with the rotation of the hollow rotor 31. In this case, the rotational force (torque) of the hollow rotor 31 is increased according to the predetermined reduction ratio of the planetary gear reduction mechanism 80, and the ball screw 41 rotates with this increased rotational force.

It should be noted that the servo motor 10, planetary gear reduction mechanism 70 and ball screw 41 are disposed coaxially about the screw shaft 41a.

There are the following operational effects according to the first embodiment and the second embodiment.

(1) According to the first embodiment and the second embodiment, the planetary gear reduction mechanism 70 (planetary gear reduction mechanism 80) is mounted between the output shaft of the servo motor 10 and the ball screw 41.

With this configuration, high loads can be endured since it is no longer necessary to have a function of a reduction mechanism in the ball screw 41 and the lead of the ball screw 41 can be lengthened by increasing the motor torque at the portion of the planetary gear reduction mechanism 70 (planetary gear reduction mechanism 80).

In addition, since the reduction ratio can be maintained by mounting the planetary gear reduction mechanism 70 (planetary gear reduction mechanism 80), it is possible to achieve high output (high pressure) even if the servo motor 10 is reduced in size; therefore, a reduction in the size of the electric spot welding gun 1 can be achieved.

(2) According to the first embodiment and the second embodiment, the servo motor 10, the planetary gear reduction mechanism 70 (planetary gear reduction mechanism 80) and the ball screw 41 are installed coaxially.

As a result, in addition to the effect of the above-mentioned (1), it is possible to achieve a more compact electric spot welding gun 1 in the width or height direction.

It should be noted that the present invention is not to be limited to the first embodiment and the second embodiment. Various modifications and improvements within a scope that can achieve the object of the present invention are included in the present invention.

For example, although a case of the number of planet gears 72 in the planetary gear reduction mechanism 70 being 4 has been explained in the above first embodiment as an example, it is not limited thereto. This number may be 5 or more, 3, 2, or 1.

Furthermore, although a case of the number of planetary gears 82 and 83 in the planetary gear reduction mechanism 80 respectively being 3 has been explained in the above second embodiment, it is not limited thereto. This number may be 4 or more, 2, or 1.

In addition, although a case of a servo motor being employed as the drive source has been explained in the above first embodiment and second embodiment, it is not limited thereto. For example, a suitable motor such as a stepping motor, inverter motor or reluctance motor may be employed.

What it claimed is:

1. A welding gun equipped with a hollow motor as a drive source, the welding gun comprising:
a pressure shaft that causes an electrode tip to advance and retract;
a ball nut that is coupled to the pressure shaft; and
a ball screw that threadedly engages with the ball nut,
wherein a reduction mechanism is attached to an output shaft of the hollow motor, and
wherein the ball screw is attached to an output shaft of the reduction mechanism.

2. A welding gun according to claim 1, wherein the hollow motor, the reduction mechanism and the ball screw are disposed coaxially.
